(19) United States
(12) Patent Application Publication
(10) Pub. No.: US 2006/0136297 A1
(43) Pub. Date: Jun. 22, 2006

(54) Method and system for providing location specific advertising content within mobile platforms

(76) Inventors: Daniel Willis, Stittsville (CA); Dhananjay Godse, Kanata (CA); Mark Lafreniere, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,973

(22) Filed: Dec. 19, 2005

Related U.S. Application Data
(60) Provisional application No. 60/636,530, filed on Dec. 17, 2004.

(51) Int. Cl. G06Q 30/00

(52) U.S. Cl. 705/14

(57) ABSTRACT

Advertising content is delivered to gaming platforms in dependence upon a location of the mobile platform. The platform provides location data either from a user of the platform, determined by the platform, for example using GPS, or through network data provided from the platform during network communication. Advertising content is then selected based on the location so determined. For mobile platforms advertising content is also distinguished based on its applicability to home address separately from the determined location.

### REFERENCE TO PRIOR APPLICATION

This application claims benefit from U.S. Provisional application 60/636,530 filed on Dec. 17, 2004, the entire contents of which is incorporated herein by reference.

### FIELD OF THE INVENTION

The instant invention generally relates to dynamic content delivery, and more particularly to a system and a method of delivering dynamic content that is dependent on the geographic location (geolocation) of the recipient.

### BACKGROUND OF THE INVENTION

During recent years, computer gaming has gained increasing popularity, and today thousands of players are playing games all around the world. Predictably, interactive computer gaming on Internet enabled platforms has blurred the line between games and other entertainment or communication media, and the avenues that are being explored in the development of gaming might well break new ground for interactive Internet applications in all areas of business relations and social life.

Due to their dynamic nature and specific appeal to certain audiences, computer games and especially games played on Internet enabled platforms provide the ideal vehicle for Internet advertising. Not only is it possible for an advertiser to target directly a specific group of customers, but also advertisements optionally are incorporated directly into the computer games, enabling something akin to the well-known concept of product placement. In such a system, a game is running on a computer that is connected to the Internet. Throughout the playing of the game, the game software contacts a set of ad servers to retrieve advertising content that is available for being displayed to the gamer during game play. The data and advertising content is transferred using, for example, HTTP protocols over the Internet. Optionally, the advertising content is cached locally to the game, and throughout the playing of the game the game software contacts a set of ad servers to retrieve a list of advertising content, selected from the cached advertising content, that is available for display to the gamer during game play.

For old fashioned radio transmission television advertising, it was always known to whom advertising data was transmitted. If a television was moved to a new location, through relocation or sale, it would receive new television broadcast signals. As such, the geographic location restriction is inherent in the medium and is enforced at the transmission end of the communication network.

Cable changed this model by transmitting signals beyond their intended geographic reach. In order to solve the above problem, cable companies replace advertisements with more geographically pertinent ones. This is achieved simply because nodes within the cable network—households—are geographically identifiable by the cable company. As such, the cable company presents certain adds to certain portions of its network and other ads to other portions.

Of course satellite television has changed this and, as such, viewers often see advertisements that are not pertinent to their day to day life and provide no value to the advertiser. Due to the very widespread area covered by the satellite signals, it is not possible to provide location based advertising to any reasonable geographic limitation. For example, the advertising content is restricted to a continent but cannot be easily restricted to a city.

In Internet advertising a similar issue arises. A single advertiser does not known a location of each visitor to their web site. The solution employed in Internet advertising is the CPA (cost per acquisition). In this business model, only interested individuals who click through or purchase based on the advertisement are counted. As such, geographic problems in advertisement evaluation are not important. An advertisement for a new restaurant in New York City only is paid for when people view the menu and/or make a reservation. This obviates any need for location based information of the user of the world wide web site.

It would be advantageous to provide a method for targeting specific users based on their geographic locations for use in broadband and wide are networks. It would also be advantageous to support relocation of platforms and mobile platforms for location based services.

### SUMMARY OF THE INVENTION

It is an object of embodiments of the present invention to provide geographic location based services to video gamers.

It is an object of embodiments of the present invention to provide geographic location based services to mobile video gamers.

In accordance with the invention there is provided a method comprising: providing a first system for executing of video games thereon and in communication with a public network; providing location data relating to the first system; selecting advertising content data in dependence upon the location data; providing the advertising content data to the first system from a server remote to the first system; and, impressing an advertisement with the first system upon a user of the first system.

In accordance with the invention there is provided a method comprising: providing first location data relating to a mobile platform, the first location data relating to a location of the mobile platform; and, providing advertising content based on the first location data.

In accordance with the invention there is provided a method comprising: providing first location data relating to a current geographical location of a mobile video game platform; updating a record of playing locations of the mobile video game platform with the first location data, to reflect the current geographical location; determining a HOME playing location based on the updated record of playing locations; communicating data to a server at a location remote from the mobile video game platform, the data indicative of the determined HOME playing location and the current geographical location of the mobile video game platform; and, receiving advertising content data from the server, the advertising content server being relevant to at least one of the HOME playing location and the current geographical location of the mobile video game platform.

In accordance with the invention there is provided a method comprising: providing first location data relating to a mobile platform, the first location data relating to a location of the mobile platform; providing advertising content based on the first location data; providing second other location data relating to a subscriber to a mobile communication service, the subscription relating to the mobile platform; and providing advertising content based on the second other location data, wherein advertising content comprises some advertising content relates to the first location data and other advertising content relates to the second other location data.

### BRIEF DESCRIPTION OF THE DRAWINGS

Embodiments of the instant invention will now be described in conjunction with the following drawings, in which:

FIG. 1 displays a schematic diagram illustrating connections and interactions between various sites connected over a network and related to advertising and gaming in accordance with an embodiment of the instant invention;

FIG. 2 is a simplified flow diagram of a method according to an embodiment of the instant invention;

FIG. 3 is a simplified flow diagram of a method according to an embodiment of the instant invention;

FIG. 4 is a simplified flow diagram of a method according to an embodiment of the instant invention; and,

FIG. 5 is a simplified flow diagram of a method according to an embodiment of the instant invention.

### DETAILED DESCRIPTION OF EMBODIMENT OF THE INVENTION

Video game players are not typically concerned about their location. A game can be played on a bus, in a car, on a plane, at home, at work, at a hotel, and so forth. When a game is played on-line, it is unimportant where the players playing the game are located so long as they have Internet connectivity. Thus, a player can play with other players regardless of their physical location. This provides location based anonymity as well as tremendous convenience.

The issue of mobility of video games arises because the location of the gaming platform is not constant. In some cases, it may be as the result of the physical relocation either temporary or permanent of an otherwise stationary device such as a desktop computer or gaming console. In other cases it may be the result of the day-to-day movement of a device that is intended to be transported; such as laptop computer, personal digital assistant (PDA), mobile personal entertainment device, or mobile phone.

The issue of mobility thus provides additional concerns for geographic location based service offerings to video game players. Furthermore, the location of the player at the instant of playing, in terms of relevance to advertising, may or may not be important. For any game being played away from the gamer's home location, advertisers will want to choose whether they care about the playing geolocation, or the home geolocation. For example, a pizzeria may choose to be advertised in any game that is being played within their market geography, regardless of the location of the user's home. However, since a person is unlikely to open a bank account while traveling on the road, many financial institutions may choose to be associated with the home location, regardless of where the user physically happens to be playing the game.

However, the definition of a user's home geolocation is inherently ephemeral. People commonly move to attend college, are relocated by new or existing employers, move closer to family, have summer homes, travel for business repeatedly to a same location, live bicoastal lifestyles, etc. In doing so, any pre-existing definition of a home geolocation is difficult to support.

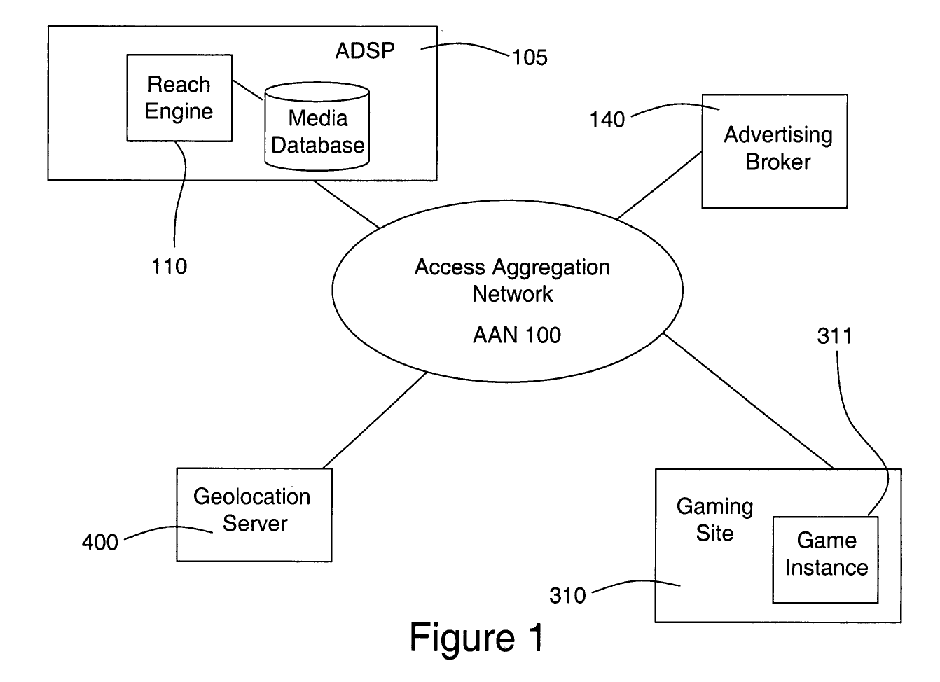

Referring now to FIG. 1, shown is a schematic diagram of a broker mediated advertisable gaming environment. The schematic diagram of FIG. 1 illustrates the single components of the broker mediated advertisable gaming environment, as well as being used for illustrating different modes of interaction therebetween. The broker mediated advertisable gaming environment comprises an advertising site, a gaming site, as well as a broker. The common linking medium establishing communication between the components is an Internet protocol wide area network WAN 100. Alternatively, another network or network protocol is used.

On the advertising site, there is provided a reach engine RE 110. The reach engine RE 110 comprises an advertisement service provider ADSP 105, and administers an inventory of different advertisements. Optionally, the advertisements are targeted to a specific group of customers based on geolocation, for example, “STATE=‘Oregon’ or STATE=‘Washington’”, or “ZIP=‘97007’”. Of course, the geolocation information is provided in as detailed or general a format as is specified and is only supported in so far as a geolocation determination for the player is determinable. Further, distinguishing the geolocation determination and the geolocation information is whether it applies to a “home” or playing geolocation.

The advertisement service provider 105 is simultaneously supporting advertising contracts for a bank and a pizzeria. Textures for the advertisement, advertising content, are stored in association with the geographic location for the advertisement to be impressed within and whether this geolocation is HOME or PLAYING or BOTH. Alternatively, the advertising content is other than texture data such as music, multimedia data, video data, or text data.

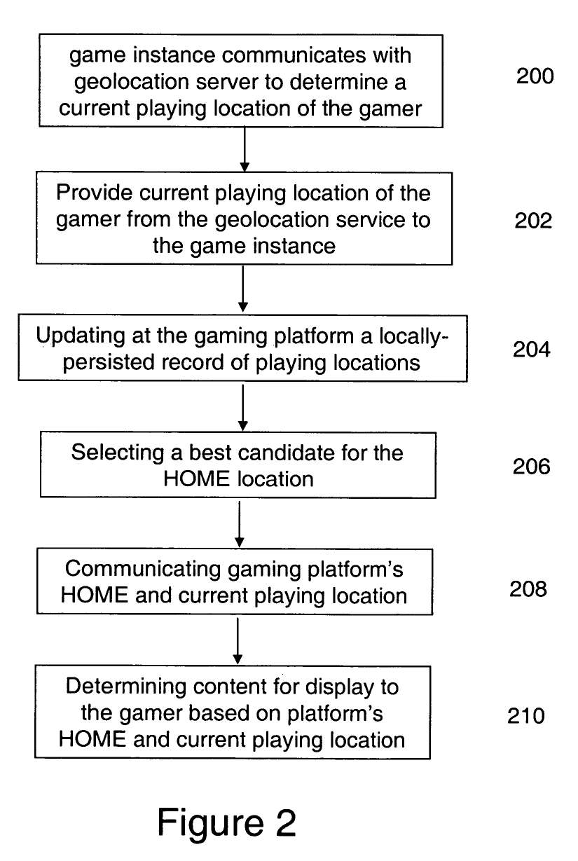

Referring to FIG. 2, shown is a simplified flow diagram of a method of displaying location based advertising content within a video game in execution on a video game console for playing of video games thereon. When at step 200 an advertising enabled game is initiated on gaming platform 310, the game instance 311 communicates with a geolocation server GS 400 to determine a current playing location of the gamer 310 based on available information, for example, IP address. This information is returned to game instance 311 at step 202. Of course, when the game is played via a cellular connection, then the cell is known thereby providing a relatively specific location from a broadcast advertising perspective. Further, incorporation of GPS or other location determination technology within the cellular network results in an even more specified playing location. Mobile phone location determination technologies are well known in the art of mobile platform locating. Optionally GS 400 is a component service of AB 140.

The gaming platform at step 204 then updates its locally-persisted record of playing locations to reflect a current playing location and at step 206 selects a best candidate for the home location. This is optionally achieved by summing up the number of instances of each location, where the contribution of each instance is weighted by “age.” Thus locations that were recorded a year ago are weighted less significantly compared to locations recorded a month ago. Examples of weighting functions include, but are not limited to, an exponential decay function based on time difference, or by the inverse of the difference of ordinality of the records. Preferably old locations are “forgotten” over time, yet individual recent locations, despite having strong weighting, do not overcome the contribution of many weaker instances of a heavily played older location. Only when a new location has been played at a sufficient number of times does it have sufficient weighting to become considered the gamer's “home” location. The choice for “home” location is optionally influenced by limiting a number of records analyzed based on quantity or time. Alternatively, HOME is determined based on billing information for a mobile device such as a mobile phone. Further alternatively, the HOME location is provided by the player.

The game instance 311 then communicates at step 208 with AB 140 for providing both the gaming platform's home and playing location. AB 140 determines content at step 210 and one or more ADSPs for serving the content to the platform. Preferably, the AB 140 indicates an ADSP for providing content to the game instance. Optionally, the AB 140 provides to the game instance 311 identifiers for the ADSPs hosting content relevant to each location. AB 140 optionally records the home and playing geolocations, for subsequent marketplace analysis.

Game instance 311 then communicates with ADSP 105, providing it with the identifying game ID and the gaming platform's geolocation data. RE 110 determines appropriate media for filling advertising spots based on the geolocation data. Similarly, game instance 311 communicates with ADSP 106, providing it with the gaming platform's geolocation data and retrieves additional media therefrom. For example ADSP 105 serves media content for the home geolocation while ADSP 106 serves content for the playing geolocation. Alternatively, ADSP 105 serves national ad campaigns while ADSP 106 serves local ad campaigns. The game instance 311 then schedules impressions of each advertising spot within the video game and based on data received and data stored in a cache of the video game system.

When the game instance 311 terminates, or a new gaming session is initialized, the gaming instance 311 communicates all unreported impressions to AB 140 for subsequent reporting and billing to ADSP 105 and ADSP 106.

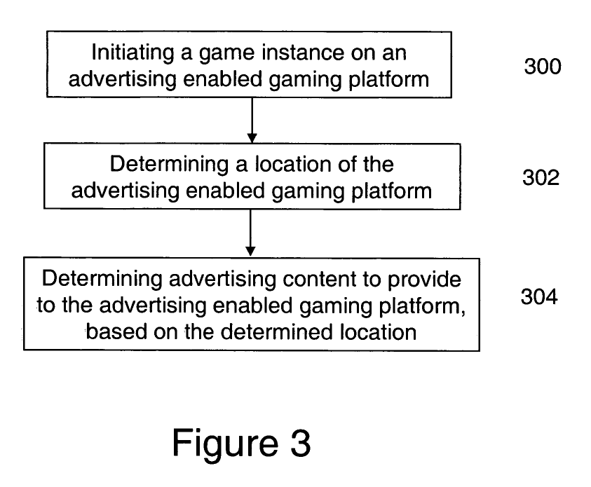

Referring to FIG. 3, shown is a simplified flow diagram of a method of displaying location based advertising content within a video game in execution on a video game console for playing of video games thereon. The geolocation of the game console is substantially fixed. Here, when an advertising enabled video game is executed at step 300, its location is estimated at step 302 by AB 140. The location information is then used at step 304 to determine ad content to provide to the game console and an appropriate ADSP for delivering of the ad content. No tracking data is maintained and, as such, this same estimation is performed each time a video game communicates with AB 140. As such, moving the video game console does not affect the overall system performance.

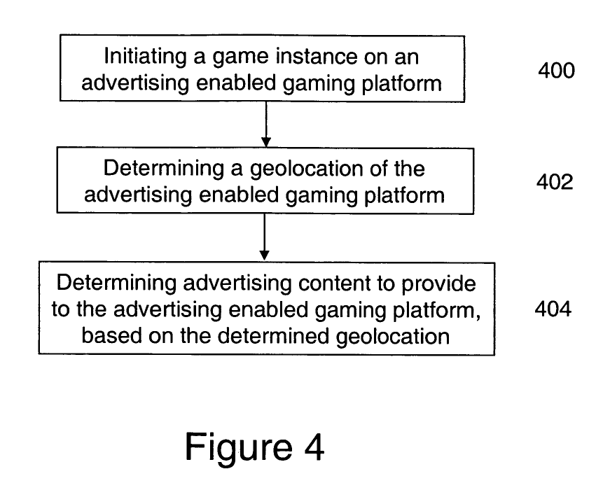

Referring to FIG. 4, shown is a simplified flow diagram of a method of displaying location based advertising content within a video game in execution on a mobile video game platform. Examples of mobile video game platforms include N-Gage® from Nokia®, SONY PSP®, and Gizmondo™. The geolocation of the mobile video game platform is optionally changed at any time including during game play. Further, Gizmondo™ includes GPS technology for self-reporting its geolocation accurately.

Here, when advertising enabled applications are executed, the platform geolocation is estimated by AB 140. Alternatively, the platform geolocation is provided either by the platform or by a service provider such as a wireless phone service provider. Methods for determining geolocation from GPS data or from wireless communication network data are well known and, as the geolocation data need not be accurate to within meters, current technology provides sufficient information for use with the present invention. The location information is then used to determine ad content to provide to the game platform and to determine an appropriate ADSP for delivering of the ad content. No tracking data is maintained and, as such, this same estimation is performed each time a video game communicates with AB 140. As such, moving the video game platform does not affect the overall system performance. Alternatively, tracking data is maintained similar to the above embodiment described with reference to FIG. 2.

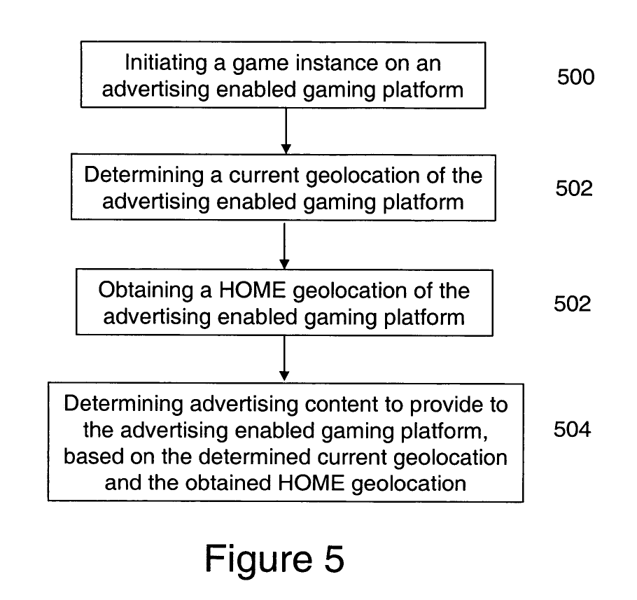

Referring to FIG. 5, shown is a simplified flow diagram of another method of displaying location based advertising content within a video game in execution on a mobile video game platform. Examples of mobile video game platforms include N-Gage® from Nokia®, SONY PSP® and Gizmondo™. The geolocation of the mobile video game platform is optionally changed at any time including during game play. Further, Gizmondo™ includes GPS technology for self-reporting its geolocation accurately.

Here, when advertising enabled applications are executed at step 500, the platform current geolocation is estimated at step 502 by AB 140. Alternatively, the platform current geolocation is provided either by the platform or by a service provider such as a wireless phone service provider. Methods for determining current geolocation from GPS data or from wireless communication network data are well known and, as the current geolocation data need not be accurate to within meters, current technology provides sufficient information for use with the present invention. HOME geolocation information is obtained at step 504. The current geolocation information and HOME geolocation information are then used to determine ad content to provide to the game platform and an appropriate ADSP for delivering of the ad content. Optionally HOME geolocation information is provided by a wireless service provider for the platform. Alternatively, the HOME geolocation is determined using historical data. Further alternatively, the HOME geolocation information is provided by the player. No tracking data is maintained and, as such, this same estimation is performed each time a video game communicates with AB. As such, moving the video game console does not affect the overall system performance. Alternatively, tracking data is maintained similar to the above embodiment described with reference to FIG. 2.

Though the above embodiments describe insertion of advertising content into video games during execution thereof, advertising content delivered to mobile platforms and based on geographic location information is generally advantageous. Further, geolocation based content delivered to mobile platforms and to video game platforms is also advantageous.

Of course, the current platform geolocation is determinable at intervals during use, when desired. Preferably, the intervals are selected so as to keep overhead processing reasonable while still providing adequate benefits of the present invention.

Numerous other embodiments may be envisaged without departing from the spirit or scope of the invention.

What is claimed is:

1. A method comprising:
providing a first system for executing of video games thereon and in communication with a public network;
providing location data relating to the first system;
selecting advertising content data in dependence upon the location data;
providing the advertising content data to the first system from a server remote to the first system; and,
impressing an advertisement with the first system upon a user of the first system.

2. A method according to claim 1 wherein the location data is determined based on network data relating to the first system.

3. A method according to claim 2 wherein the advertising content data relates to advertising for one of wares of services within a predetermined distance of a location represented by the location data.

4. A method according to claim 3 wherein the predetermined distance is defined by an advertiser associated with the advertising content.

5. A method according to claim 2 wherein the advertising content data relates to advertising for one of wares and services near a location represented by the location data.

6. A method according to claim 5 wherein the advertising content data relates to advertising for one of wares and services within walking distance of a location represented by the location data.

7. A method according to claim 1 wherein the location data is provided by a user of the first system.

8. A method according to claim 1 wherein the location data is provided automatically by the first system.

9. A method according to claim 8 wherein the advertising content data relates to advertising for one of wares and services within a predetermined distance of a location represented by the location data.

10. A method according to claim 9 wherein the predetermined distance is defined by an advertiser associated with the advertising content.

11. A method according to claim 8 wherein the advertising content data relates to advertising for one of wares and services near a location represented by the location data.

12. A method according to claim 11 wherein the advertising content data relates to advertising for one of wares and services within walking distance of a location represented by the location data.

13. A method according to claim 1 comprising:
determining based on the location data a first location of the first system and a second other location of the first system, the second other location relating to one of a home and an office location for a user of the first system.

14. A method according to claim 13 wherein the advertising content data relates to one of the first location and the second other location.

15. A method according to claim 14 wherein advertising content data is stored in association with advertising location data providing an indication of where the advertising content data is to be distributed.

16. A method according to claim 15 wherein the advertising location data indicates a preference between home location data, playing location data, and both.

17. A method according to claim 1 wherein the advertisement is impressed upon the user of the first system.

18. A method according to claim 1 wherein the advertisement is impressed upon the user of the first system other than during execution of the video game.

19. A method according to claim 1 wherein the advertisement is impressed upon the user of the first system upon the first system providing data indicative of a predetermined location.

20. A method according to claim 1 wherein the first system comprises a mobile gaming platform.

21. A method according to claim 1 wherein the first system comprises a mobile phone.

22. A method according to claim 1 wherein the advertisement is a multimedia advertisement.

23. A method according to claim 1 wherein the advertising content data relates to advertising for one of wares and services within a predetermined distance of a location represented by the location data.

24. A method according to claim 23 wherein the predetermined distance is defined by an advertiser associated with the advertising content.

25. A method comprising:
providing first location data relating to a mobile platform for execution of a video game thereon, the first location data relating to a location of the mobile platform; and,
providing advertising content based on the first location data.

26. A method according to claim 25 comprising:
providing second other location data relating to a subscriber to a mobile communication service, the subscription relating to the mobile platform; and
providing advertising content based on the second other location data,
wherein advertising content comprises some advertising content relates to the first location data and other advertising content relates to the second other location data.

27. A method according to claim 26 comprising:
impressing the advertising content upon a user of the mobile platform, wherein some advertising content relating to the first location data and other advertising content relating to the second other location data each result in advertisements impressed upon the user of the mobile platform.

28. A method comprising:
providing first location data relating to a current geographical location of a mobile video game platform;
updating a record of playing locations of the mobile video game platform with the first location data, to reflect the current geographical location;
determining a HOME playing location based on the updated record of playing locations;
communicating data to a server at a location remote from the mobile video game platform, the data indicative of the determined HOME playing location and the current geographical location of the mobile video game platform; and,
receiving advertising content data from the server, the advertising content server being relevant to at least one of the HOME playing location and the current geographical location of the mobile video game platform.

29. A method comprising:
providing first location data relating to a mobile platform, the first location data relating to a location of the mobile platform;
providing advertising content based on the first location data;
providing second other location data relating to a subscriber to a mobile communication service, the subscription relating to the mobile platform; and
providing advertising content based on the second other location data,
wherein advertising content comprises some advertising content relates to the first location data and other advertising content relates to the second other location data.
